(19) United States
(12) Patent Application Publication
(10) Pub. No.: US 2002/0050153 A1
(43) Pub. Date: May 2, 2002

(54) Method and apparatus for creating a refractive gradient in glass using laser energy

(76) Inventors: Peter Schultz, Bogart, GA (US); Dmitri Nikitin, Daytona Beach Shores, FL (US); Thomas Michel, Eustis, FL (US); Vladimire Borissovskii, Lake Mary, FL (US)

Correspondence Address: Finnegan, Henderson, Farabow,, Garrett & Dunner, L.L.P., 1300 I Street, N.W., Washington, DC, 20005-3315, US

(21) Appl. No.: 09/845,664

(22) Filed: Apr. 30, 2001

Related U.S. Application Data
(63) Continuation-in-part of application No. 09/516,937, filed on Mar. 1, 2000.

(51) Int. Cl. C03B 37/01

(52) U.S. Cl. 65/377; 65/384; 65/415; 65/417; 65/441; 65/444; 65/484; 65/530

(57) ABSTRACT

Methods, systems, and apparatus consistent with the present invention apply one or more laser beams to a glass object, such as a tube. The beams may have differing wavelengths, energy levels, and/or focal length characteristics. As the beam (single or multiple) penetrates the glass tube, it creates a channel. The beam is provided through the channel to a starting point on a region of the glass tube, usually the region below an inside diameter surface of the tube. In one embodiment, the beam is used to selectively heat a reactant gas within the tube to deposit a coating/dopant layer on the inside diameter surface. In another embodiment, the coating layer is already present and the beam selectively heats the layer causing thermal diffusion of the coating material into the glass tube at the region being heated. Next, the laser beam is moved relative to the glass tube while the beam is selectively heating portions of the tube causing further thermal diffusion and creating a refractive gradient design within the tube with the laser energy.

### RELATED APPLICATIONS

This application is a continuation-in-part of U.S. patent application Ser. No. 09/516,937 entitled METHOD APPARATUS AND ARTICLE OF MANUFACTURE FOR DETERMINING AN AMOUNT OF ENERGY NEEDED TO BRING A QUARTZ WORKPIECE TO A FUSION WELDABLE CONDITION, which was filed on Mar. 1, 2000. This application is also related to several commonly owned applications that were concurrently filed on ______ as follows: U.S. patent application Ser. No. ______ entitled “METHOD AND APPARATUS FOR FUSION WELDING QUARTZ USING LASER ENERGY”, U.S. patent application Ser. No. ______ entitled “METHOD AND APPARATUS FOR PIERCING AND THERMALLY PROCESSING QUARTZ USING LASER ENERGY”, U.S. patent application Ser. No. ______ entitled “METHOD AND APPARATUS FOR CONCENTRICALLY FORMING AN OPTICAL PREFORM USING LASER ENERGY”, and U.S. patent application Ser. No. ______ entitled “METHOD AND APPARATUS FOR THERMALLY PROCESSING QUARTZ USING A PLURALITY OF LASER BEAMS.”

### BACKGROUND OF THE INVENTION

A. Field of the Invention

This invention relates to systems for thermally processing quartz using laser energy and, more particularly stated, to systems and methods for using one or more beams of laser energy to selectively heat parts of a glass object while moving the laser energy relative to the tube in order to create a refractive gradient within the glass object.

B. Description of the Related Art

One of the most useful industrial glass materials is quartz glass. It is used in a variety of industries: optics, semiconductors, chemicals, communications, architecture, consumer products, computers, and associated industries. In many of these industrial applications, it is important to be able to join two or more pieces together to make one large, uniform blank or finished part. For example, this may include joining two or more rods or tubes “end-to-end” in order to make a longer rod or tube. Additionally, this may involve joining two thick quartz blocks together to create one of the walls for a large chemical reactor vessel or a preform from which optical fiber can be made. These larger parts may then be cut, ground, or drawn down to other usable sizes.

Many types of glasses have been “welded” or joined together with varying degrees of success. For many soft, low melting point types of glass, these attempts have been more successful than not. However, for higher temperature compounds, such as quartz, welding has been difficult. Even when welding of such higher temperature compounds is possible, the conventional processes are typically quite expensive and time-consuming due to the manual nature of such processes and the required annealing times.

When attempting to weld quartz, a critical factor is the temperature of the weldable surface at the interface of the quartz workpiece to be welded. The temperature is critical because quartz itself does not go through what is conventionally considered to be a liquid phase transition as do other materials, such as steel or water. Quartz sublimates, i.e., it goes from a solid state directly to a gaseous state. Those skilled in the art will appreciate that quartz sublimation is at least evident in the gross sense, on a macro level.

In order to achieve an optimal quartz weld, it is desirable to bring the quartz to a condition near sublimation but just under that point. There is a relatively narrow temperature zone in that condition, typically between about 1900 to 1970 degrees Celsius (C.), within which one can optimally fusion weld quartz. In other words, in that usable temperature range, the quartz object will fuse to another quartz object in that their molecules will become intermingled and become a single piece of water clear glass instead of two separate pieces with ajoint. However, quartz vaporizes above that temperature range, which essentially destroys part of the quartz workpiece at the weldable surface. Thus, achieving an optimal quartz fusion weld is not trivial and typically involves controlling how much energy is applied so that the quartz workpiece or object reaches a weldable condition without being vaporized.

In addition to using laser energy to fusion weld quartz together, there is a need for a method or system that can quickly and easily create a refractive index or refractive gradient within the quartz. Today, a majority of silica glass fiber optics for telecommunications are made using vapor deposition techniques in quartz glass. One conventional method, called MCVD, begins with a bait tube of quartz or highly purified silica (SiO₂). The tube is generally heated with a flame as the tube is rotated. When reactant gases (metal halides and oxygen) pass through the heated tube, they react to deposit a soot material on the inside diameter surface of the tube. Heat from the flame then melts the soot to form a sintered glass having a desired refractive gradient characteristic. When the heat from the flame is turned up, the tube collapses into a solid rod (also called an optical preform) where the deposited material becomes the light-carrying core of the fiber while the rest of the tube forms the cladding for the fiber. These conventional fabrication methods result in radially symmetric and uniform refractive index gradients, which are axially constant in the resulting fiber.

Fiber core refractive gradient profiles have become more and more complex as optical physicists try to increase the bandwidth of fiber and create efficient optical communication systems. For example, a fiber having a ribbon or planer core refractive gradient may be useful to the optical physicist as an efficient polarization maintaining fiber. Such a fiber can be made from a glass tube with today's conventional techniques, but the processes to make them are difficult, imprecise and generally result in inefficient polarization and high optical loss characteristics of the fiber.

Other examples of axially non-symmetric and non-uniform refractive gradients include spots, rings, stripes, helical designs, and other shapes within or on the surface in virtually any geometric pattern. Creating these refractive gradients within glass requires even more precision as to the amount of energy applied and where the energy is applied. Unfortunately, conventional methods often fail to offer or, at best, provide only a crude ability to create such refractive gradients structures for use in fiber optics.

Accordingly, there is a need for a system and method that can quickly, efficiently, and economically process any region within the quartz to create radially and axially non-symmetric and non-uniform refractive gradients that would give the optical designer additional freedom to efficiently design core and cladding structures in optical fibers not found before.

### SUMMARY OF THE INVENTION

Methods, systems, and articles of manufacture consistent with the present invention overcome these shortcomings by using laser energy to create a refractive gradient within a glass tube. The directed nature and precision of beams of laser energy provide a way in which to apply and selectively heat portions of coating materials, which will then diffuse into the glass forming the desired refractive gradient at the desired position within the glass tube.

More particularly stated, a method consistent with the present invention, as embodied and broadly described herein, begins with applying a beam of laser energy to the glass tube. The beam penetrates the glass tube to create a channel. Once the channel has been created, the laser beam is provided through the channel to a starting point on a region of the glass tube. Typically, the region is an inside diameter surface of the glass tube having a coating or dopant layer that is heated by the laser beam. Normally, the beam is provided to the starting point (and other points as the beam is moved) for a predetermined amount of time causing diffusion at a desired depth. The design of the refractive gradient is created by moving the beam of laser energy relative to the starting point while the beam is selectively applied. Relative movement of the beam and the tube while selectively applying the beam to the tube may be rotational, linear along a longitudinal axis of the tube or a combination of both.

In another aspect of the present invention, as embodied and broadly described herein, a method for creating a refractive gradient within a glass object begins by focusing multiple beams of laser energy as a composite beam at a starting point. Next, the composite beam is applied to an inside diameter surface and inner region of the glass object below the inside diameter surface. When the inside diameter surface and the inner region are selectively heated using the composite beam, a first change in the refractive index characteristic of the inside diameter surface and inner region occurs. In one embodiment, the composite beam can also be used to selectively heat a reactant gas disposed within the glass object causing the reactant gas to deposit a coating or dopant layer on the inside diameter surface and the adjacent surface for further heating by the composite beam.

The composite beam is then moved relative to the glass object so that the composite beam selectively heats an adjacent surface and an adjacent region below the adjacent surface. Such movement is typically accomplished by a relative rotation, linear translation along a longitudinal axis of the glass object or a combination of rotation and linear movement between the glass object and the composite beam. Heating the adjacent surface and the adjacent region causes a second change in the refractive index characteristic such that the first change and the second change collectively form the refractive gradient within the glass object.

In yet another aspect of the present invention, as embodied and broadly described herein, an apparatus for creating a refractive gradient within a glass tube is described as having a laser energy source and a reflective conduit configured to receive a beam of laser energy from the laser energy source. The reflective conduit is also configured to selectively direct the beam of laser energy onto dopant material on an inside diameter (ID) surface of the tube causing thermal diffusion of the dopant material into the glass tube. The reflective conduit can be altered to cause movement or essentially to move the beam of laser energy relative to the ID surface causing further thermal diffusion of the dopant material and creating the refractive gradient within the glass tube. Such movement may be rotational, linear or a combination of rotating and linearly moving the reflective conduit relative to the glass object.

In a final aspect of the present invention, as embodied and broadly described herein, an apparatus for creating a refractive gradient within a glass tube has a laser energy source for selectively providing a beam of laser energy at a selectable energy level. The beam from the laser energy source is provided to dopant material on an inside diameter (ID) surface of the glass tube. The apparatus also includes a movable working surface positioned relative to the laser energy source. The movable working surface is configured to support the glass tube as the beam of laser energy is applied causing thermal diffusion of the dopant material into the glass tube. The movable working surface can also selectively move the glass tube as the beam of laser energy is selectively applied from the laser energy source causing further thermal diffusion of the dopant material and creating the refractive gradient within the glass tube. Such movement may be rotational, linear or a combination of rotating and linearly moving the working surface (and the glass positioned on the working surface) relative to the orientation of the laser beam.

### BRIEF DESCRIPTION OF THE DRAWINGS

The accompanying drawings, which are incorporated in and constitute a part of this specification, illustrate an implementation of the invention. The drawings and the description below serve to explain the advantages and principles of the invention. In the drawings,

FIG. 1, consisting of FIGS. 1A-1D, is a diagram illustrating an exemplary quartz laser fusion welding system consistent with an embodiment of the present invention;

FIG. 2, consisting of FIGS. 2A-2B, is a diagram illustrating a lathe-type quartz laser fusion welding system optimized for tubular quartz workpieces consistent with an embodiment of the present invention;

FIG. 3 is a functional block diagram illustrating components within the exemplary quartz laser fusion welding system consistent with an embodiment of the present invention;

FIG. 4, consisting of FIGS. 4A-4B, is a diagram illustrating a welding zone between quartz objects being laser fusion welded consistent with an embodiment of the present invention;

FIG. 5 is a diagram illustrating a laser energy source having multiple laser beams consistent with an embodiment of the present invention;

FIG. 6, consisting of FIGS. 6A-6C, is a diagram illustrating how a laser beam can be used to thermally process a quartz object and create refractive gradients of variable geometries as the beam and/or the quartz are moved relative to each other consistent with an embodiment of the present invention;

FIG. 7, consisting of FIGS. 7A-7C, is a diagram illustrating a cross section of an exemplary quartz object as a beam of laser energy is applied and moved relative to the object causing creation of a refractive gradient consistent with an embodiment of the present invention;

FIG. 8, consisting of FIGS. 8A-8B, is a cross sectional diagram illustrating thermal diffusion of coating material before and after being thermally processed by a beam of laser energy to cause diffusion of the metal coating into the quartz consistent with an embodiment of the present invention;

FIG. 9 is a flow chart illustrating typical steps for using laser energy to create refractive gradients within a glass or quartz object consistent with an embodiment of the present invention; and

FIG. 10 is a flow chart illustrating more detailed steps for using laser energy to create refractive gradients within a glass or quartz object consistent with another embodiment of the present invention.

### DETAILED DESCRIPTION

Reference will now be made in detail to an implementation consistent with the present invention as illustrated in the accompanying drawings. Wherever possible, the same reference numbers will be used throughout the drawings and the following description to refer to the same or like parts.

In general, methods and systems consistent with the present invention apply laser energy to a quartz workpiece, such as two quartz objects, in order to pierce a quartz object, selectively heat any internal portion of the object using such laser energy in a delicate and almost surgical manner, and then use the laser energy to fusion weld back together the quartz object. Extending this general concept, methods and systems consistent with the present invention use laser energy to create refractive gradients within the quartz via selective heating of gases and/or dopant coating materials deposited within the quartz.

Those skilled in the art will appreciate that use of the terms “quartz”, “quartz glass”, “vitreous quartz”, “vitrified quartz”, “vitreous silica”, and “vitrified silica” are interchangeable regarding embodiments of the present invention. Additionally, those skilled in the art will appreciate that the term “thermally process” means any type of glass processing that requires heating, such as cutting, annealing, or welding.

In more detail, when quartz transitions from its solid or “super-cooled liquid” state to the gaseous state, it evaporates or vaporizes. The temperature range between the liquid and gaseous state is somewhere between about 1900 degrees C. and 1970 degrees C. The precise transition temperature varies slightly because of trace elements in the material and environmental conditions. When heated from its solid or super-cooled state to a still super-cooled but very hot, more mobile state, the quartz becomes tacky or thixotropic. Applicants have found that quartz in this state does not cold flow much faster than at lower elevated temperatures and it does not flow (in the sense of sagging) particularly fast but it does become very sticky.

As the temperature approaches the transition range, the thermal properties of quartz change radically. Below 1900 degrees C., the thermal conductivity curve for quartz is fairly flat and linear (positive). However, at temperatures greater than approximately 1900 degrees C. and below the sublimation point, thermal conductivity starts to increase as a third order function. As the quartz reaches a desired temperature associated with the fusion weldable state, applicants have discovered that it becomes a thermal mirror or a very reflective surface.

The quartz thermal conductivity non-linearly increases with thermal input and increasing temperature. There exists a set of variable boundary layer conditions that thermal input influences. This influence changes the depth of the boundary layer. This depth change results in or causes a dramatic shift in the thermal characteristics (coefficients) of various thermal parameters. The cumulative effect of the radical thermal conductivity change is the cause of the quartz material's abrupt change of state. When its heat capacity is saturated, all of the thermal parameters become non-linear at once, causing abrupt vaporization of the material.

This boundary layer phenomenon is further examined and discussed below. The subsurface layers of the quartz workpiece have, to some depth, a coefficient of absorption which is fixed at “Initial Conditions” (IC) described below in Table 1.

TABLE 1

| | |
|---|---|
| Let the coefficient of thermal absorption of laser | k |
| radiation be: | |
| Let the depth of the sub-surface layer be: | d |
| Let the coefficient of heat capacity be: | c |
| Let the coefficient of reflectance be: | r |
| Let the coefficient of thermal conduction be: | λ |
| Let the density be: | ρ |

As the quartz is heated over a temperature range below 1900 degrees C., k increases but with a shallow slope, and d remains relatively constant and fairly large.

However, applicants have found that as the temperature exceeds 1900 degrees C., the slope of k increases at a third-order (cubic) rate until it becomes asymptotic with an increase in thermal conductivity. Simultaneously, the depth of sub-surface penetration d 15 decreases similarly. This causes an increase in the thermal gradient within the quartz object that reduces the bulk thermal conductivity but increases it at the thinning boundary layer on the weldable surface of the object.

As a result, the heat energy is concentrated in the boundary layer at the weldable surface. As this concentration occurs, the coefficient of thermal conductivity increases. These dramatic, non-linear, thermal property changes in the boundary layer create a condition where the energy causes the (finite) weldable surface of the quartz object to become quasi-fluid. As explained above, this condition is at the ragged edge of sublimation. A few more calories of heat and the quartz vaporizes. It is within this temperature range and viscosity region that effective quartz fusion welding can occur. The difficulty in attaining these two conditions simultaneously is that (1) in general, heating is a random, generalized process, and (2) heating is not a precisely controllable parameter. Embodiments of the present invention focus on applying laser energy in order to selectively pierce a quartz object, selectively heat or otherwise thermally process an inner portion of the quartz object and then fusion weld quartz object back together.

For optimal fusion welding, it is important to determine how much heat is needed to raise the quartz object's temperature to just under the vaporization or sublimation point. As described in related U.S. Patent application Ser. No. 09/516,937, the amount of energy (energy from a laser, or other heat source) that is required to heat a quartz object to its thermal balance point (thermal-equilibrium) is preferably determined prior to applying that energy to the quartz object, which is incorporated by reference. The present application focuses on how the energy is applied to one or more quartz objects that make up a quartz workpiece.

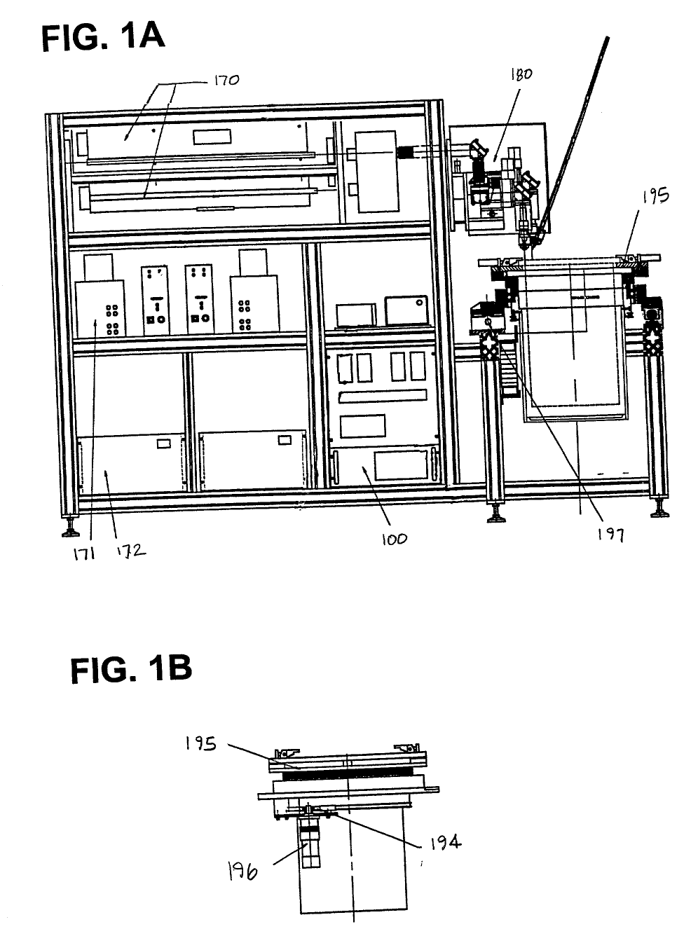

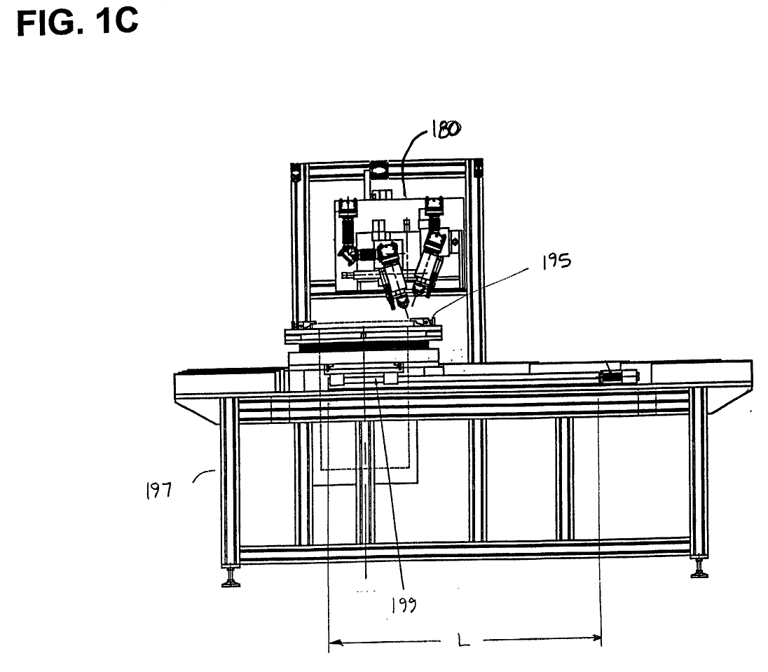

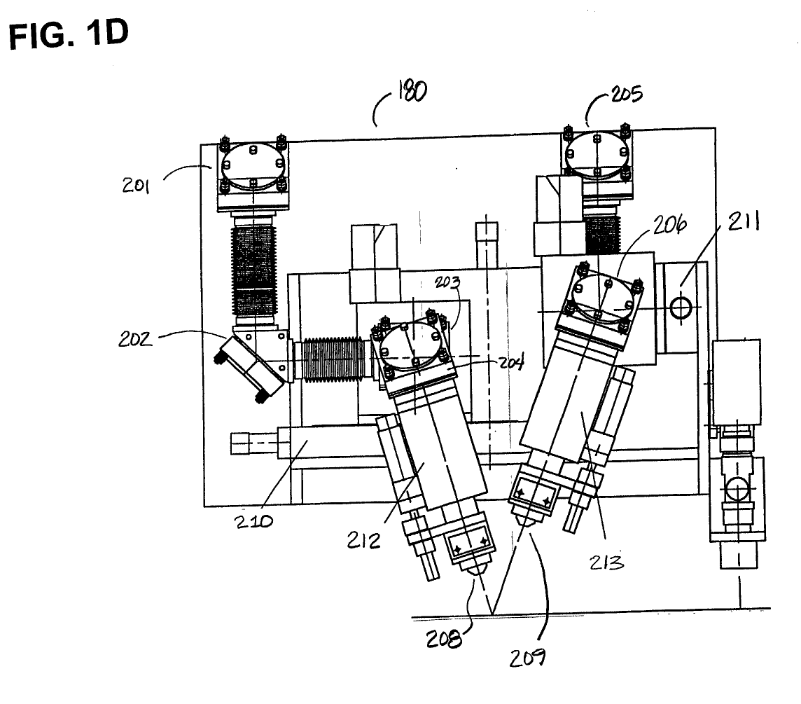

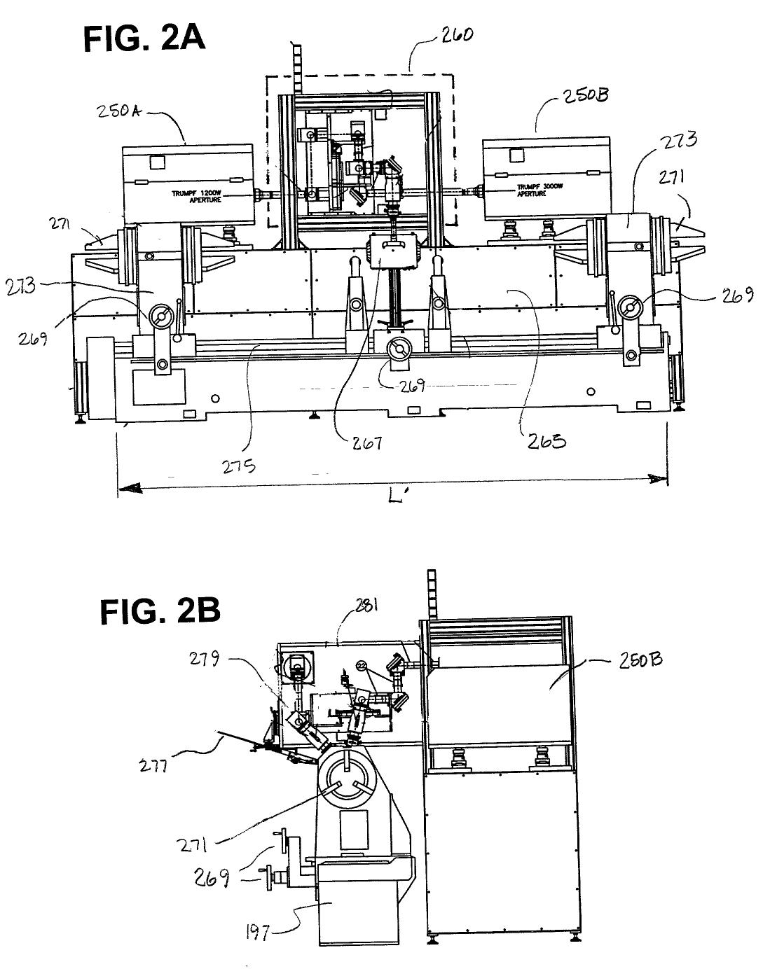

Two types of exemplary quartz fusion welding systems are illustrated in FIGS. 1A-1D and 2A-2B that are each suitable for applying laser energy to fusion weld quartz objects consistent with the present invention. The exemplary system illustrated in FIGS. 1A-1D is a general quartz fusion welding system that uses a table and movable working surface to support and move the workpiece as laser energy is applied. However, the exemplary system illustrated in FIGS. 2A-2B is configured with a lathe-type of support for optimal holding and turning of a lengthy tubular workpiece as laser energy is applied.

Referring now to the first example system in FIGS. 1A-ID, the exemplary quartz fusion welding system is a general and flexible laser welding system that includes a laser energy source 170, a movable welding head 180 (more generally referred to as a reflecting head), a movable working surface 195 that supports the quartz workpiece being processed on a table 197 and a computer system (not shown) that controls the system. Each part of this system will now be described in more detail.

Laser energy source 170 is typically one or more lasers, each of which being powered by a power supply and cooled using a refrigeration system. As used within this application, the term “laser energy source” or “laser” should be broadly interpreted to be a lasing element and may include a subsystem having power supplies, refrigeration and terminal optics capable of producing a particular focal length. For example, the laser energy source may be implemented with terminal optics to achieve a focal length of 3.75 inches and a focal spot size of 0.2 mm in diameter. Other focal characteristics are possible with the focal characteristics of movable welding head 180 and the optics dispose therein.

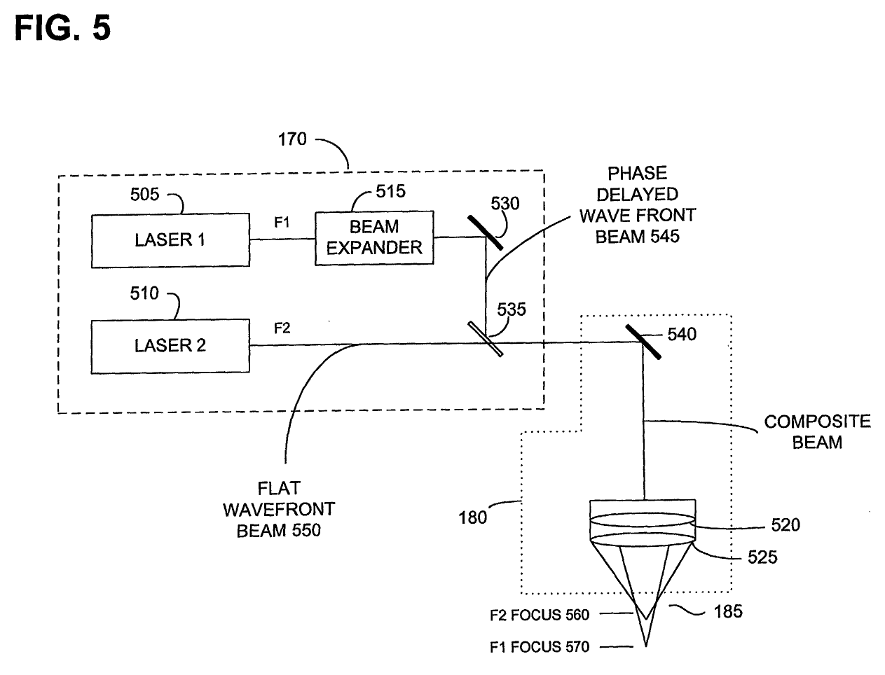

In one embodiment, laser energy source 170 is implemented with multiple lasers, which are combined to produce a composite beam. Those skilled in the art will appreciate that each of these lasers can have the same or different wavelengths, such as 355 nm or 3.5 microns, as part of a laser energy source consistent with an embodiment of the present invention. The use of multiple lasers and a composite beam is discussed further with regard to FIG. 5 below.

In the embodiment shown in FIG. 1A), laser energy source 170 is implemented as two lasers—an optional preheating laser and another laser for additional processing (e.g., cutting, welding, heating, etc.) of a workpiece. In this embodiment, the preheating laser is a sealed Trunpf Laser Model TLF 1200t CO₂ laser having a predefined wavelength of 10.6 microns and capable of providing up to 1200 Watts of laser power. The second laser is a sealed Trumpf Laser Model TLF 3000t CO₂ laser having a predefined wavelength of 10.6 microns and capable of providing up to 3000 Watts of laser power. The exact power and characteristics of such preheating and processing lasers will vary according to the materials being processed.

When two quartz objects (not shown) are to be fusion welded, the objects are placed in a pre-weld configuration on movable working surface 195. In general, the pre- weld configuration is a desired orientation of each object relative to each other. More specifically, the pre-weld configuration places a surface of one quartz object proximate to and substantially near an opposing surface of the other quartz object. These two surfaces form a gap or channel between the object where the laser energy is to be applied. Those skilled in the art will appreciate that the pre-weld configuration for any quartz objects will vary depending upon the desired joining of the objects.

FIGS. 1B and 1C are diagrams illustrating views of the exemplary working table 197. Referring now to FIG. 1B, a portion of the working table 197 is shown as having movable working surface 195 that is rotatable. The working surface 195 supports the glass or quartz workpiece (e.g., a glass tube, two quartz rods, etc.) and rotates in response to commands or signals from computer 100 to rotational actuator 196 (typically implemented as a DC servo actuator). A timing belt 194 connects the output of the DC motor within rotational actuator 196 to the working surface 195. Thus, working surface 195 rotates the configuration of the supported quartz workpiece(s) on table 197.

FIG. 1C illustrates a side view of table 197. Linear actuator 199 is disposed and configured to move the working surface 195 (and rotational actuators and controls) along length L so that the quartz workpiece or object being processed are linearly moved relative to the welding head 180.

After placement of the quartz objects into the pre-weld configuration, laser energy source 170 provides energy in the form of a laser beam 175 to movable welding head 180 under the control of the computer system (not shown). Movable welding head 180 receives laser beam 175 and directs its energy in a beam 185 to the quartz workpiece in accordance with instructions from computer system (not shown). While it is important to apply laser energy when fusion welding two quartz objects in an embodiment of the present invention, it is desirable that the system have the ability to selectively direct how and where the laser energy is applied relative to the quartz objects themselves. To provide such an ability, the laser energy is applied in a selectable vector (an orientation and magnitude) relative to the quartz objects being fusion welded.

Selecting or changing the vector can be accomplished by moving the laser energy relative to a fixed object or moving the object to be welded relative to a fixed source of laser energy. In the exemplary embodiment, it is preferably accomplished by moving both the quartz objects being welded (by moving and/or rotating the working surface 195 under control of the computer) and by moving the vector from which the laser energy is applied (using actuators to move angled reflection joints within movable welding head 180). In this manner, the system provides an extraordinary degree of freedom by which laser energy can be selectively applied to the quartz object(s).

Movable welding head 180 is used to direct laser energy consistent with an embodiment of the present invention and is shown in more detail in FIG. 1D. Referring now to FIG. 1D, movable welding head 180 is an example of a reflective conduit for directing the laser energy from laser energy source 170 to the welding zone between the quartz objects being welded. In the exemplary embodiment, movable welding head 180 (generally called a movable head or reflective conduit) directs laser beams using angled reflective surfaces (e.g., mirrors or other types of reflectors) within elbows of a selectively re-configurable arrangement of angled reflection joints.

Furthermore, in the exemplary embodiment where laser energy source 170 includes two lasers, those skilled in the art will appreciate that the first laser projects a beam that is directed through reflection joints 201, 202, 203, 204 before exiting welding head 180 at output 208. Similarly, the second laser projects another beam of laser energy that is directed through another series of angled reflection joints 205, 206, 207 before exiting welding head 180 at another output 209. Those skilled in the art will appreciate that the alignment of the directed laser energy depends upon the orientation of each joint and its relative position to the other joints.

In the exemplary embodiment, welding head 180 is movable in relation to the source of laser energy 170. This allows positioning of the welding head 180 to selectively alter where the laser energy is to be applied while using a fixed or stationary source of laser energy. In more detail, welding head 180 includes a series of actuators capable of moving the angled reflection joints relative to each other. For example, welding head 180 includes actuators (x-axis actuator 210 and y-axis actuator 211), which permit movement of the laser beams directed out of laser. The welding head actuators are typically implemented using an electronically controllable crossed roller slide having a DC motor and an encoder for sensing the movement.

In the second example system in FIGS. 2A-2B, the support structure for the workpiece and the welding head has been optimized to easily manipulate tubular workpieces that are rotated as the laser energy is applied. In such a configuration, this optimized second system is commonly referred to as a “butt-welder” given its ability to weld different sized tubes together with a weld that is perpendicular to the longitudinal axis of the tubes.

As shown in FIG. 2A, this second system includes a warming laser energy source 250A, a welding laser energy source 250B, a movable welding head 260 (more generally referred to as a reflecting head), a lathe-type support structure 265 that supports the quartz workpiece being processed and a computer system (not shown) that controls the system. The lasers 250A, 250B are characteristically similar to the lasers described in the first example. However, the orientation of each output of the welding head 260 (i.e., warming optics 279 and welding optics 281) is altered to orient the laser beams onto a desired point or surface of the tubular workpiece (not shown). In the embodiment shown in FIG. 2B, warming optics 279 and welding optics 281 have multiple axis of motion providing a desired level of flexibility and configurability.

The tubular workpiece may be one or two glass tubes held in place by the lathe-type support structure 265. In more detail, the lathe structure 265 includes one or more adjustable chucks 271, each of which are disposed on movable lathe stands 273. Each chuck grasps, supports, and holds the tubular glass or quartz workpiece as it is being processed. The lathe stands 273 (more generally called a glass lathe) cause the grasped workpiece to rotate under control of the computer system. Optional muffler 267 is typically disposed between the lathe stands 273 and supports the tubular workpiece as it is rotated.

The positions of muffler 267 and each lathe stand 273 along length L′ on track 275 are selectably manipulated using actuators 269. These positions can be manipulated so that the tubular quartz objects being welded or otherwise processed (i.e., the workpiece) are linearly moved relative to movable welding head 260. In the embodiment in FIG. 2A, the actuators 269 are one or more manually positioned wheels connected to screw-driven positioners (not shown) within each of the lathe stands 273 and the muffler 267. In another embodiment, it is contemplated that the actuators may be electronically or mechanically controlled, using stepper motors or solenoids. Thus, chuck 271 and lathe 273 are a type of working surface, which supports the workpiece and is movable in a linear and rotational sense to selectively position the workpiece relative to the movable welding head 260.

In yet another embodiment (not shown), it is contemplated that the laser energy source itself can be selectively moved relative to the glass object. This may be accomplished via electronically controllable actuators coupled to the laser energy source, a controlled robotic positioning system coupled to the source or any other mechanical structure that can be used to provide multiple degrees of freedom and positioning of the source. It is contemplated that such actuators or other positioning devices may be used to orient and position the laser energy source such that the laser beam exits the source and is applied directly at a desired point on the glass object. One skilled in the art will appreciate that this alternative embodiment alleviates the need for a reflective conduit (e.g., welding head 180) which indirectly (via one or more reflective devices) provides and selectively directs the laser beam onto the desired point on the glass object.

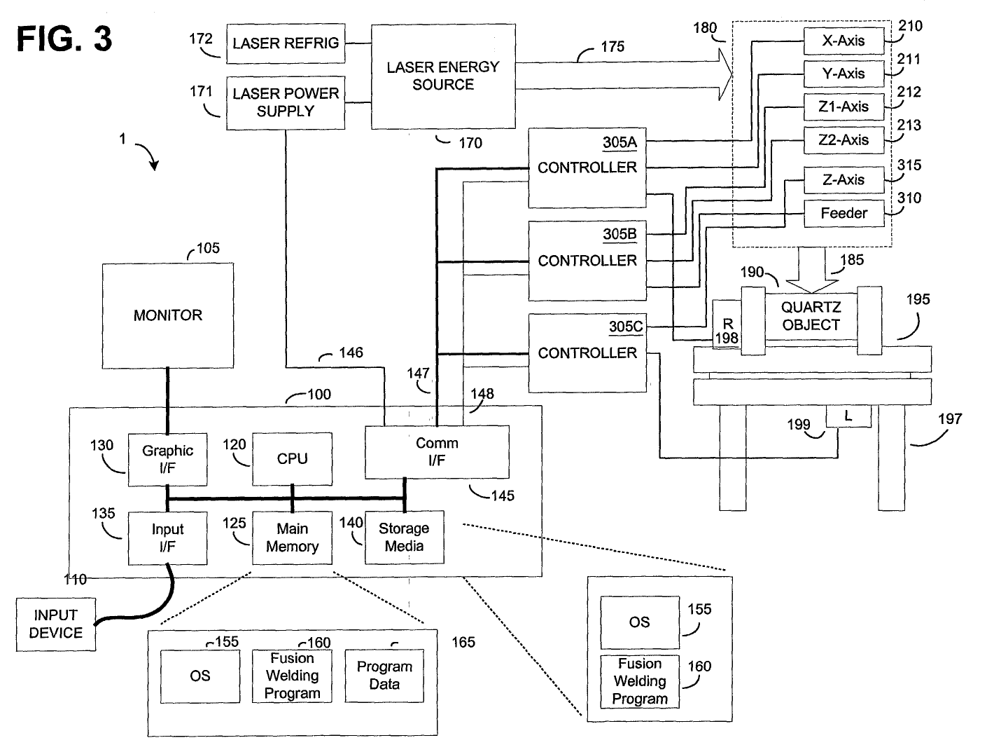

FIG. 3 is a functional block diagram illustrating components within an exemplary quartz laser fusion welding system consistent with an embodiment of the present invention. While FIG. 3 shows a computer system and controllers interacting with components from the example welding system shown in FIGS. 1A-1D, those skilled in the art will appreciate that the same computer and controllers may be used with similar components from the alternative example welding system shown in FIGS. 2A-2B.

Referring now to FIG. 3, computer system 100 sets up and controls laser energy source 170, movable welding head 180, and movable working surface 195 (implemented as the lathe and chuck in FIGS. 2A-2B) in a precise and coordinated manner during thermal processing (e.g., fusion welding, selective heating, or cutting open) of the quartz objects on working surface 195. The computer system 100 typically turns on laser energy source 170 for discrete periods of time providing a selective energy level for the resulting beam. The computer system 100 also controls the positioning of movable welding head 180 and movable working surface 195 relative to the quartz objects being processed so that surfaces on the objects can moved and be easily processed (e.g., heated, welded, cut open, re-fused, etc.) in an automated fashion. As discussed and shown in FIGS. 1A-1D, movable working surface 195 typically includes actuators allowing it to move along a longitudinal axis (preferably the x-axis) as well as rotate relative to the movable welding head 180.

Looking at computer system 100 in more detail, it contains a processor (CPU) 120, main memory 125, computer-readable storage media 140, a graphics interface (Graphic I/F) 130, an input interface (Input I/F) 135 and a communications interface (Comm I/F) 145, each of which are electronically coupled to the other parts of computer system 100. In the exemplary embodiment, computer system 100 is implemented using an Intel PENTIUM III® microprocessor (as CPU 120) with 128 Mbytes of RAM (as main memory 125). Computer-readable storage media 140 is preferably implemented as a hard disk drive that maintains files, such as operating system 155 and fusion welding program 160, in secondary storage separate from main memory 125. One skilled in the art will appreciate that other computer-readable media may include secondary storage devices (e.g., floppy disks, optical disks, and CD-ROM); a carrier wave received from a data network (such as the global Internet); or other forms of ROM or RAM.

Graphics interface 130, preferably implemented using a graphics interface card from 3Dfx, Inc. headquartered in Richardson, Tex., is connected to monitor 105 for displaying information (such as prompt messages) to a user. Input interface 135 is connected to an input device 110 and can be used to receive data from a user. In the exemplary embodiment, input device 110 is a keyboard and mouse but those skilled in the art will appreciate that other types of input devices (such as a trackball, pointer, tablet, touchscreen or any other kind of device capable of entering data into computer system 100) can be used with embodiments of the present invention.

Communications interface 145 electronically couples computer system 100 (including processor 120) to other parts of the quartz fusion welding system 100 to facilitate communication with and control over those other parts. Communication interface 145 includes a connection 146 (preferably using a conventional I/O controller card or interface) to laser energy source 170 used to setup and control laser energy source 170.

In the exemplary embodiment, this connection 146 is to laser power supply 171. Those skilled in the art will recognize other ways in which to connect computer system 100 with other parts of fusion welding system 1, such as through conventional IEEE-488 or GPIB instrumentation connections.

In the exemplary embodiment of the present invention, communication interface 145 also includes an Ethernet network interface 147 and an RS-232 interface 148 for connecting to hardware that implement control systems within movable welding head 180 and movable working surface 195. The hardware implementing such control systems includes controllers 305A, 305B, and 305C. Each controller 305A-C (preferably implemented using Parker 6K4 Controllers) is controlled by computer system 100 via the RS-232 connection and the Ethernet network connection. Communication with the control system hardware through the Ethernet network interface 147 uses conventional TCP/IP protocol. Communication with the control system hardware using the RS-232 interface 148 is typically for troubleshooting and setup.

Looking at the hardware in more detail, controllers 305A-305C control the actuators necessary to selectively apply the laser energy to a surface of a quartz object supported by the chuck on the lathe. Specifically, controller 305A is configured to provide drive signals to actuators on the welding head, and rotational (“R”) actuator 198. Controller 305B is typically configured to provide drive signals to other actuators on the welding head and a fill rod feeder (“Feeder”) actuator 310 attached to the movable welding head 180. Similarly, controller 305C is configured to provide drive signals to the rest of the welding head actuators and linear (“L”) actuator 199 for linear movement of the working surface 195 of table 197.

Each of the drive signals are preferably amplified by amplifiers (not shown) before sending the signals to control a motor (not shown) within these actuators. Each of the actuators also preferably includes an encoder that provides an encoder signal that is read by controllers 305A-C.

Once computer system 100 is booted up, main memory 125 contains an operating system 155, one or more application program modules (such as fusion welding program 160), and program data 165. In the exemplary embodiment, operating system 155 is the WINDOWS NT™ operating system created and distributed by Microsoft Corporation of Redmond, Wash. While the WINDOWS NT™ operating system is used in the exemplary embodiment, those skilled in the art will recognize that the present invention is not limited to that operating system. For additional information on the WINDOWS NT™ operating system, there are numerous references on the subject that are readily available from Microsoft Corporation and from other publishers.

Fusion Welding Process

In the context of the above described system, fusion welding program 160 causes a specific amount of laser energy to be applied to the quartz objects that are in the pre-weld configuration in a controlled manner. This is typically accomplished by manipulating the movable welding head 180 and movable working surface 195. The laser energy is advantageously and uniformly applied to the object surfaces being fusion welded.

As part of setting up to fusion weld two quartz objects together or simply thermally process a quartz object supported in the chuck, the quartz workpiece of one or more objects is placed in a pre-weld configuration relative to the chuck and lathe and soaked at an initial preheating temperature to help avoid rapid changes in temperature that may induce stress cracks within the resulting fusion weld. In the exemplary embodiment, the preheating temperature is typically between 500 and 700 degrees C. and is preferably applied with the preheating laser. Other embodiments may include no preheating or may involve applying energy for such preheating using the beam of laser energy itself or energy from other heat sources, such as a hydrogen-oxygen flame.

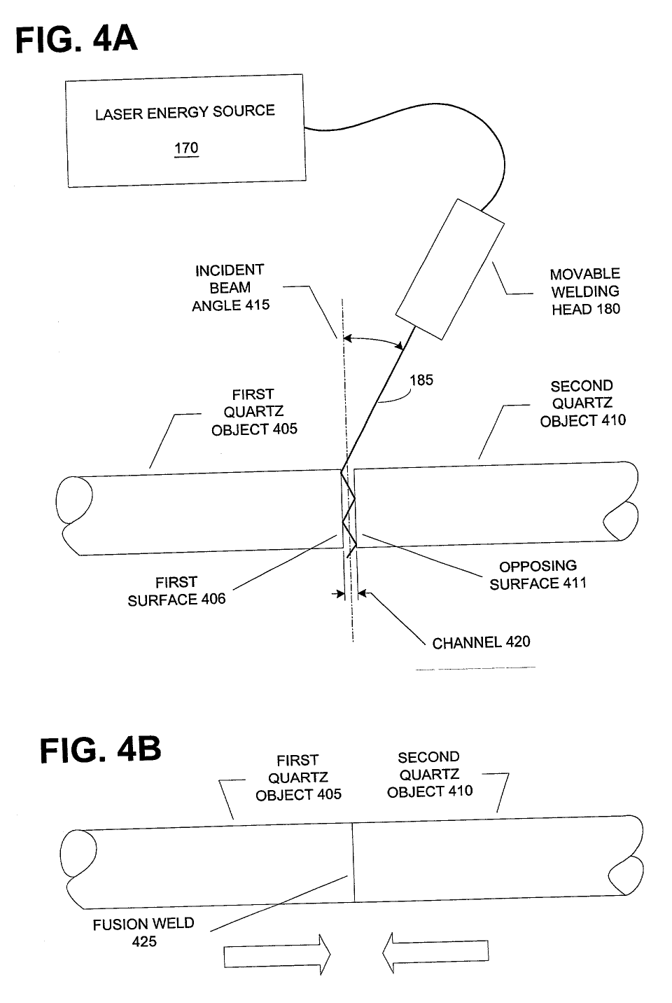

Once preheated, fusion welding program 160 determines how much energy is needed to bring the surfaces of the quartz objects to the desired fusion weldable condition without vaporizing quartz material. Quartz fusion welding system 1 then aligns the source of laser energy by positioning the movable welding head 180 to provide laser beam 185 to a welding zone between the objects being welded. FIGS. 4A and 4B are diagrams illustrating a welding zone between exemplary quartz objects being laser fusion welded consistent with an embodiment of the present invention.

Referring now to FIG. 4A, a first quartz object 405 is disposed on a movable working surface (such as working surface 195 or lathe 273 with chuck 271) next to a second quartz object 410 after being preheated. For clarity, the first quartz object 405 and the second quartz object 410 are illustrated as stock quartz rods that have end surfaces 406 and 411, respectively, that are to be fusion welded together.

When placing the first quartz object 405 in a pre-weld configuration with the second quartz object 410 before preheating, surface 406 on the first object 405 is placed proximate to and substantially near opposing surface 411 on the second object 410. In this configuration, the end surfaces 406, 411 define a gap or channel 420 between the objects.

After preheating, laser energy source 170 generates laser energy in the form of laser beam 185 that is directed to the welding zone between the objects. Movable welding head 180 operates to align the energy and direct laser beam 185 to end surface 406 of the first object 405. This is typically accomplished by focusing the laser beam at an incident beam angle 415 of approximately 0-10 degrees (this may vary depending upon the type, geometry, and character of the material being thermally processed by the laser) from the centerline of the channel. While the exemplary environment typically uses an approximately 0-10 degree incident beam angle when launching laser beam 185 into channel 420, those skilled in the art will realize that there are situations where different geometries of materials may require a different angle of incidence for the laser beam for it to be reflected and distributed along the channel 420. For example, if the first quartz object 405 is a rod or cylindrical object that is being fusion welded to a planar second quartz object (not shown), then the incident beam angle may be from approximately 0-45 degrees above the planar surface. In other examples, the angle of

As surface 406 absorbs the incident laser energy from laser beam 185 and the surface is increasingly heated, the surface 406 becomes shiny and reflective. In other words, as the surface 406 approaches a fusion weldable condition, the quartz surface 406 reaches a reflective state. In this reflective state, surface 406 bounces or transfers the energy of the laser beam 185 to opposing surface 411. As a result, opposing surface 411 also reaches the reflective state and laser beam 185 is repeatedly reflected down the length of channel 420 heating surfaces 406 and 41 Ito a substantially uniform or even distribution. This advantageously allows for precise and substantially even heating of surfaces deep within channel 420. Once the surfaces to be welded reach the reflective state and distribute the heat, the surfaces reach a fusion weldable condition so that the surfaces will molecularly fuse together to form a fusion weld.

FIG. 4B is a diagram illustrating the first object 405 after it is fusion welded to the second object 410. The reflected laser energy has heated both end surfaces to reach a fusion weldable condition and then both objects were joined together in a fusion weld 425 where the molecules from the first object 405 become intermingled with the molecules of the second object 410. Those skilled in the art will appreciate that causing the objects to join and then fuse may be due to gravity or due to an applied compressive force.

Additionally, those skilled in the art will appreciate that it is possible to use a glass fill rod to fill in channel 420 and complete the fusion weld. Essentially, the fill rod is fed into the channel as the surfaces in the channel are heated. While fusion weld 425 is illustrated as a visible line in FIG. 4B, those skilled in the art will also appreciate that the resulting fusion welded quartz will be a singular object with no visible seam, crack or demarcation to show the weld.

As previously mentioned, it is contemplated that the laser beam can be multiple laser beams that form a composite beam with advantageous heating zones. Using multiple laser beams is often useful and desired when the area to be heated is relatively thick and there is a need to create a lengthy heating zone (also called a laser beam focal field). With multiple laser beams, selective focusing of the laser beams can also alter how the energy is applied to the object to achieve such a lengthy heating zone.

Referring now to FIG. 5, details within laser energy source 170 and movable welding head 180 in an embodiment of the invention are further illustrated to show how multiple laser beams can be selectively focused. In this example, laser energy source 170 comprises a first laser (Laser1) 505 and a second laser (Laser2) 510, each of which can be selectively turned on/off or modulated to deliver a desired amount of energy within their beams. Laser1 505 and Laser2 510 are preferably implemented as programmably controllable sealed CO₂ lasers that selectively provide Gaussian beam profiles at powers of up to 3000W, and may have the same or different wavelengths, energy levels, and focal points.

The beams from each laser are combined or bundled together coaxially or collaterally to form a composite laser beam. The applicants have found that it may be advantageous to combine the laser beams and produce the composite beam using different focal points, different wavelengths, and/or different energy levels. These differing characteristics of the two beams produce a flexible zone of highly concentrated energy. In the example illustrated in FIG. 5, those skilled in the art will appreciate that Laser1 505 provides a laser beam F1 to abeam expander 515, which delays the phase of the F1 wave front. This creates a phase-delayed wave front 545 that is reflected off reflector 530. Combiner/reflector 535 then joins phase-delayed wave front 545 with a flat wave front beam 550 (also called the F2 wave front), which is provided by Laser2 510, to produce an integrated or composite laser beam.

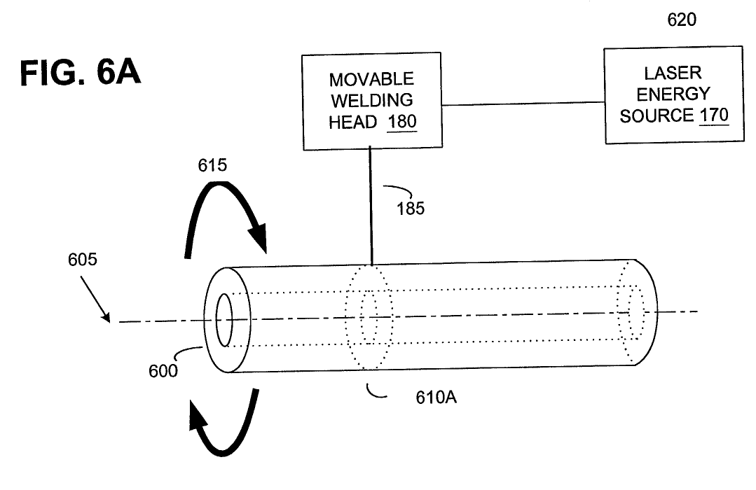

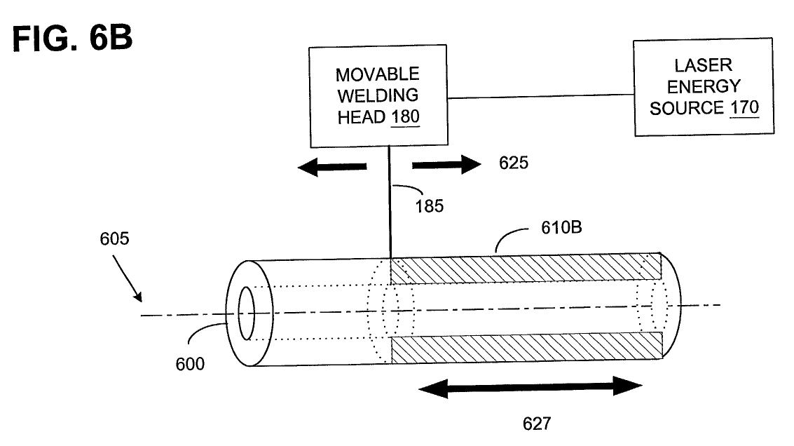

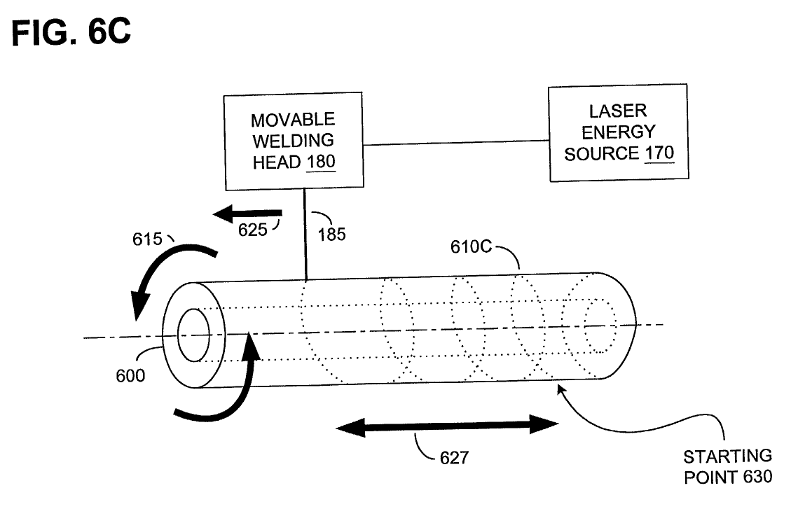

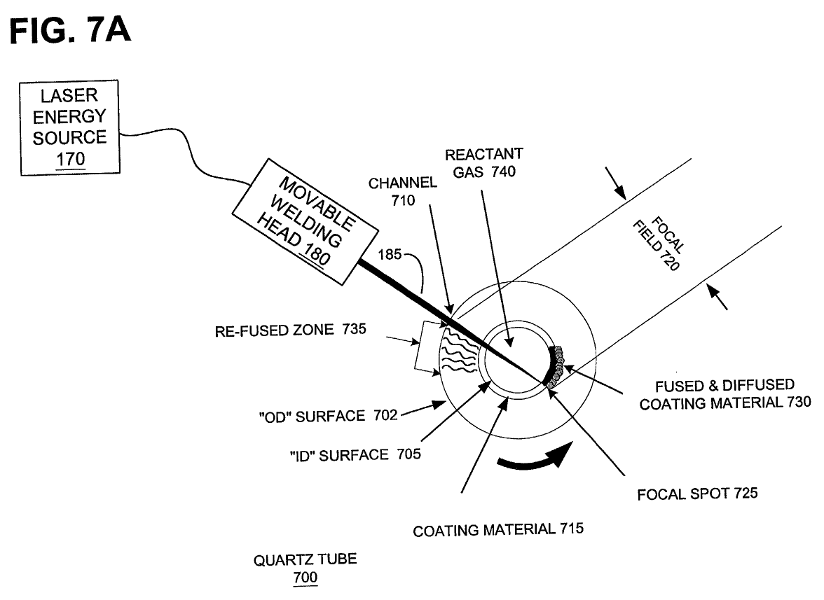

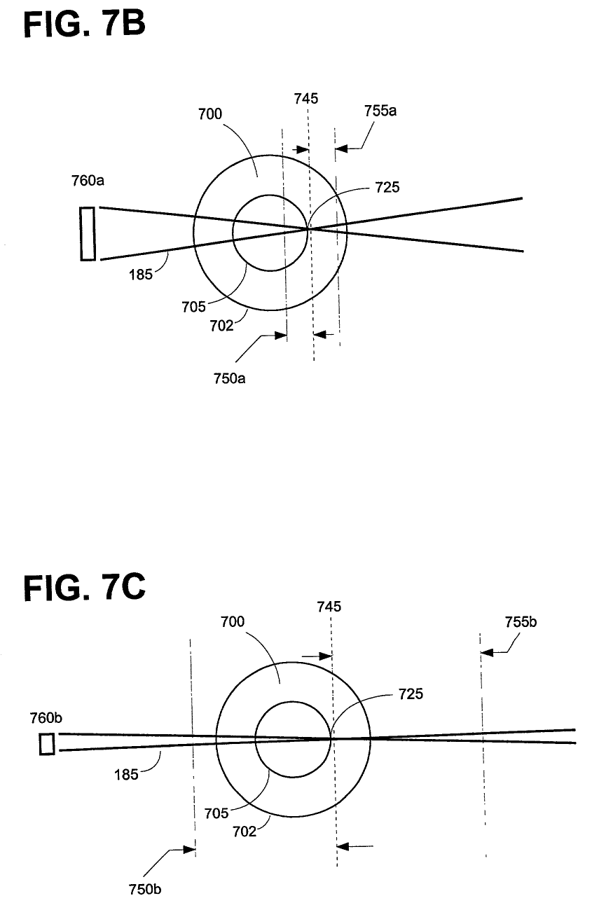

The composite laser beam is preferably provided to the moveable welding head, reflected through a series of reflectors 540 and then provided onto lenses 520, 525. The ability to selectively focus lens 520 and lens 525 by moving lenses 520, 525 relative to each other and phase-delaying one of the beams provides the ability to create a zone of high energy concentration (also called the heating zone or focal zone) between the F1 focus point 570 and the F2 focus point 560. Thus, the superposition of multiple foci produces a relatively lengthy and high energy focal field, which can be used to selectively heat or fusion weld quartz within that area as the composite beam is moved relative to the quartz. The ability to use multiple lasers each with different wavelengths, energy levels, and/or focal lengths provides additional flexibility to the composite beam to facilitate enhanced processing of the quartz and/or other dopant materials heated by the beam as the beam moves relative to the glass. Movement of this focal field through a glass or quartz object is shown and explained in more detail below with regard to FIGS. 6A-6C and 7.

In an embodiment of the present invention, the laser beam is moved relative to a glass object (such as a glass tube) so that regions within or on the object are selectively heated. Using the laser beam to heat particular doped regions of the glass (or regions coated with a raw dopant layer) can advantageously produce refractive gradient structures in the glass object, such as spots, rings, ribbons, stripes, helixes, or any other curvilinear structure of virtually any geometric pattern. Specifically, heating the doped glass or dopant layer with the laser for a predetermined amount of time causes migration of the dopant further into the glass and, thus, creates a refractive gradient structure. Selectively controlling the amount of energy applied via the laser beam and the amount of time the laser beam is applied to a specific point allows for control of the depth of the thermally induced dopant diffusion. One skilled in the art will quickly appreciate that use of a movable working surface (e.g., surface 195 or lathe 273 and chuck 271) and a directable laser energy source (e.g., laser energy source 170 in combination with movable welding head 180, one or both of lasers 250A, 250B in combination with movable welding head 260 or a movable laser energy source (not shown)) permit the optical fiber designer a degree of freedom and flexibility not previously available when designing refractive core and cladding structures which may have desired light carrying benefits for communication and sensor applications.

In FIGS. 6A-6C, an embodiment of the present invention is illustrated where different types of movement of the glass object relative to the laser beam are shown when creating a refractive gradient structure within the object. There are many different ways in which the laser beam and/or the glass object may be moved relative to each other in order to alter where laser energy is applied on or within the glass object. For purposes of this patent application, reference to “movement relative to” the laser and glass object should be interpreted to mean that either the laser or the glass object or both are actually placed in motion with respect to each other. The important aspect is that the relative orientation of the laser beam and glass object is changed during such movement regardless of which (the beam or the object) is actually moved.

Rotational movement relative to the glass object and the beam is graphically illustrated in FIG. 6A. Referring now to FIG. 6A, the object is a glass tube 600 horizontally oriented rotating about a longitudinal axis 605. In this embodiment, rotation 615 of the tube 600 is caused when the supporting structure, such as a glass lathe and chuck or movable working surface, is precisely moved via actuators. While rotation in the exemplary embodiment is accomplished by rotating the workpiece, the same rotational movement may also be caused by rotating the movable welding head 180 about the longitudinal axis 605 of the tube 600 while the tube either remains still or also rotates about its axis 605. In this manner, the laser beam traces a circumferential path providing a radially oriented trace 610A. Thus, if the laser beam were heating dopant material within the tube 600 while the beam was rotated relative to the tube, the resulting refractive gradient would be radially shaped, similar to the radially oriented trace 610A. Translational or linear movement of the glass object relative to the laser beam is shown in FIG. 6B. Referring now to FIG. 6B, glass tube 600 is supported in a horizontal position. In this embodiment, linear movement 625 of the movable welding head 180 is caused by driving the appropriate actuator. In this manner, the laser beam traces a linear path providing a linear trace through tube 600. Again, if the laser beam were heating dopant material within the tube 600 while the beam was linearly moved relative to the tube, the resulting refractive gradient would be a planar structure, such as a ribbon 610B. Additionally, linear movement 627 of the workpiece via actuated movement of the structure supporting the workpiece (e.g., lathe 273 and chuck 271 or working surface 195) instead of or in addition to linear movement 625 results in such a planar gradient structure.

Using a combination of these types of movement (rotational and linear) and selectively applying the laser beam, virtually any pattern of laser tracing can be created. For example, a helical path may be traced as is shown in FIG. 6C. Referring now to FIG. 6C, the combination of rotational movement 615 of the tube and linear movement 625 of the movable welding head is illustrated. In this manner, the laser beam traces a helical path on tube 600. Those skilled in the art will appreciate that linear movement 627 of the workpiece and rotational movement (not shown) of the welding head may also be used to create such a helical path. If the laser beam were heating dopant material within the tube 600 while the beam was rotationally and linearly moved relative to the tube, the resulting refractive gradient would be a helical structure 610C. Furthermore, if the beam is modulated, pulsed or otherwise selectively applied during such relative movement of the beam and glass, those skilled in the art will quickly appreciate that virtually any pattern of refractive gradient can be created within the glass object.

In the context of the above description, a cross section of an exemplary glass tube is shown in FIG. 7, consisting of FIGS. 7A-7C, as a beam of laser energy is applied and moved relative to the glass tube consistent with an embodiment of the present invention. FIG. 7A shows the application of the beam as the tube rotates while FIGS. 7B and 7C highlight different focal field settings when applying the beam to the tube.

Referring now to FIG. 7A, laser energy source 170 and movable welding head 180 provide beam 185 to quartz tube 700 (shown in cross-sectional view). In this exemplary embodiment, beam 185 is initially applied to the outside diameter (OD) surface 702 of tube 700. At this point, the energy level of beam 185 is high enough to pierce tube 700 by forming channel 710. The energy level of beam 185 can be altered or changed by lowering its power level as it exits laser energy source 170, changing modulation characteristics of the beam 185, or altering the focal characteristics of beam 185 (whether a single or multiple beams). After forming channel 710 through the body of the tube, the energy being applied is again altered so that beam 185 is applied and focused on a focal spot 725 on an inside diameter (ID) surface 705 on the tube 700.

In an embodiment of the present invention, the laser beam is used to selectively heat a reactant gas, such as a metal halide and oxygen, disposed within tube 700 to deposit a layer or coating within an inner surface of the tube. In order to selectively heat the reactant gas, the depth of focus or focal field is selectively adjusted so that laser energy is concentrated within a larger area of the gasified hollow central core area of the tube 700. This is further explained below with regard to FIGS. 7B and 7C.

Referring to FIGS. 7B and 7C, an example of long and short focal fields are illustrated that define high energy concentration areas or heating zones. A focal point or focal spot is the finite plane in space that the laser focus reaches its smallest dimension or the laser beam reaches its highest intensity. The depth of focus or focal field is a zone on each side of that plane in space. In the focal field, there is sufficient concentration of laser energy to produce localized heating of the material, such as the glass in the tube 700, but not to the extreme intensity as that of the focal point. As the depth of focus becomes smaller or shallower, the angle of focus becomes higher and the faster the laser energy converges to the focal point and diverges from the focal point. For example, FIG. 7B illustrates a relatively shallow depth of field compared to that shown in FIG. 7C.

More particularly, beam 185 is applied through lens 760a and focused on focal plane 745 to provide a relatively shallow focal field in FIG. 7B. In front of focal plane 745 is a reactive energy zone 750a of the focal field that is sufficiently intense as to heat materials or gases disposed within that zone. On the other side of the focal plane 745 is considered a non-reactive zone 755a when laser power has been dissipated in the reactive zone 750a and the focal spot 725 on focal plane 745. In the example illustrated on FIG. 7B, the focal field is smaller than that illustrated in FIG. 7C due to the terminal optics 760a, 760b. Thus, those skilled in the art will appreciate that selection and/or adjustment of the terminal optics or lenses 760a, 760b allows reactive energy zone 750b to be made larger, thus heating more of the tube (or reactive gases disposed within the tube) when compared to when reactive energy zone 750a of FIG. 7B. This is often helpful in controlling the amount of heat applied to a particular part of tube 700.

When the reactant gas is selectively heated as described above, the deposited layer or coating is typically an unfused or raw metal coating material 715 (generally referred to as a coating layer of dopant material). Those skilled in the art will appreciate that examples of such a coating material include but are not limited to metals, metal halides and/or rare earth elements.

Referring back to FIG. 7A, the coating material may already have been deposited within the tube using conventional vapor deposition techniques known in the fiber optic industry. In this other embodiment, the laser beam is used to selectively heat the coating material 715. As heat is selectively applied to the coating material 715 via the laser beam 185, the coating material becomes fused 730 with the ID surface causing thermal migration of the material within an inner region below and proximately near the focal spot 725 of the beam 185. In this manner, the material in the coating layer migrates into the inner region by thermal diffusion depending upon the energy level of the beam and upon the amount of time the laser beam is applied to the coating at that particular point. Those skilled in the art will appreciate that the actual time for applying the laser beam can be experimentally determined based on the thickness of the coating material being fused, the energy of the laser, the thickness of the tube, and the desired migration profile.

As the beam and the tube are moved relative to each other, the welding channel 710 is re-fused (shown in zone 735) as the focal spot 725 moves along the ID surface 705 to an adjacent surface and adjacent underlying region to the recently fused coating material 730. Thus, as the beam 185 (and its focal spot 725 and focal field 720) moves to different locations (e.g., points on the ID surface 705 the regions of the tube beneath such heated points), the resulting fused and diffused material within the tube become the refractive gradient. Depending upon how the beam and tube are moved relative to each other, the refractive gradient is advantageously created with a variety of geometries.

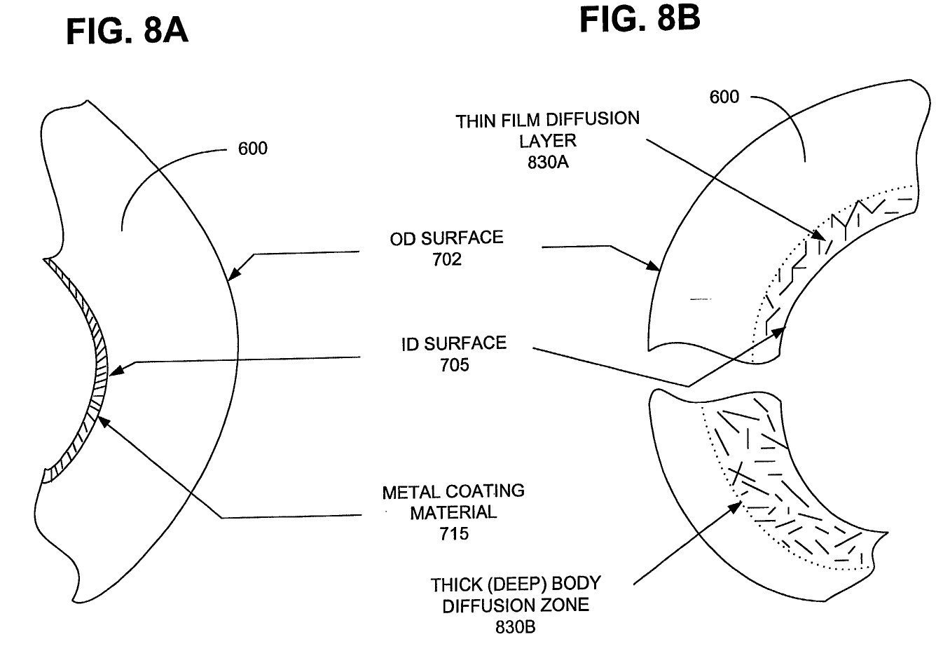

Looking at thermally induced diffusion in more detail, FIGS. 8A-8B are cross sectional diagrams illustrating examples of thermal diffusion of a metal coating before and after being thermally processed by a beam of laser energy consistent with an embodiment of the present invention. FIG. 8A illustrates the ID surface 705 having a coating 715 deposited on it prior to heating the coating. However, once the coating 715 and the region of the tube 600 just below that coating have been heated, thermal diffusion of the coating material 715 takes place as shown in FIG. 8B.

Referring now to FIG. 8B, thermal diffusion of the coating material 715 is illustrated in two different examples where the laser beam was selectively applied for differing periods of time. In the first example, the amount of energy imparted by the laser beam 185 was low enough to only create a thin film diffusion layer 830A below the ID surface 705. One way in which this may be accomplished is to apply the laser beam to the coating material 715 for a relatively short period of time. However, if deeper diffusion is desired, the amount of energy imparted by the laser beam can be selectively increased to create a deeper refractive gradient, such as thick (deep) body diffusion zone 830B. This is typically accomplished by increasing the energy of the beam itself or by applying the beam for a longer period of time to creates such a thick diffusion zone 830B. Thus, precise application of energy via a laser, movement of the laser relative to the glass object and selectively applying the laser can provide an efficient and clever way to create rather complex refractive gradients.

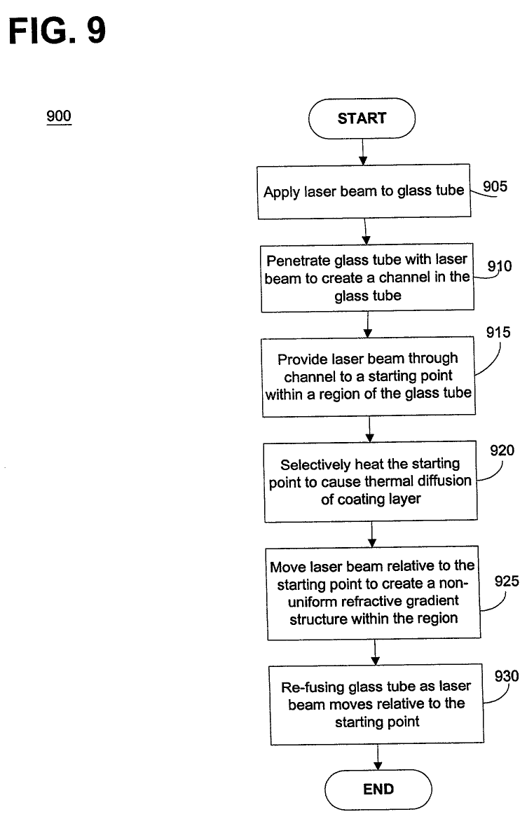

In the context of such a laser-based system capable of thermally processing quartz objects, FIG. 9 is a flow chart illustrating typical steps for using laser energy to create refractive gradients within a glass or quartz object consistent with an embodiment of the present invention. Referring now to FIG. 9, the method 900 begins at step 905 where a beam of laser energy, such as beam 185, is applied to a glass tube. At step 910, the energy of the laser beam is high enough to cause the beam to form a channel that penetrates into the glass tube.

At step 915, the laser beam is provided through the channel to a starting point on a region of the glass tube. In the exemplary embodiment, laser beam 185 bores through tube 700 forming channel 710. Beam 185 is then provided through channel 710 and applied to focal spot 725 on ID surface 705. Alternatively, beam 185 may be selectively focused such that focal spot 725 is at a predefined depth within coating material 715.

At step 920, the starting point is selectively heated to cause thermal migration of the coating layer. As discussed before, the energy applied using the laser beam causes migration of the dopant material from the coating layer 715 into the glass region near the starting point. The extent of thermal diffusion will, amongst other things, depend upon how long the beam is applied to the starting point. The longer the beam is applied, the more energy from the laser beam is applied causing a greater extent of migration to occur.

At step 925, the laser beam is moved relative to the starting point. As mentioned before, moving the beam relative to the starting point should be interpreted to encompass actually moving the laser beam without moving the glass tube, moving the glass tube without moving the beam, or any type of combination where both the glass tube and the laser beam are moved. This type of movement, while selectively applying the laser beam, creates a design of refractive gradient structures within the glass tube.

During such movement, the glass is re-fused at step 930 where the channel used to be. In the exemplary embodiment, movement of the beam 185 causes energy to be applied to adjacent surfaces and regions within the tube 700 while the beam 185 is used to re-fusion weld the tube, as shown in the re-fused zone 735 in FIG. 7.

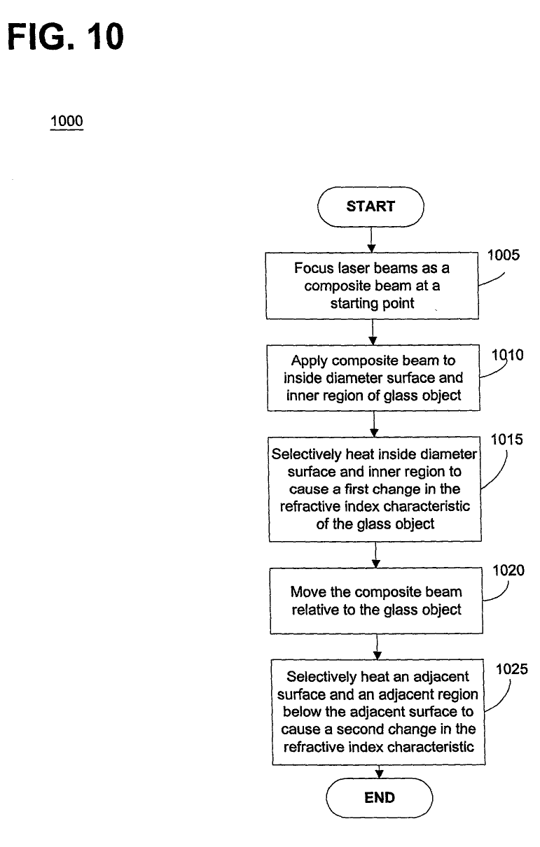

FIG. 10 is a flow chart illustrating more detailed steps for using laser energy to create refractive gradients within a glass or quartz object consistent with another embodiment of the present invention. Referring now to FIG. 10, the method 1000 begins at step 1005 where at least two laser beams are focused as a composite beam at a starting point on a glass object. At step 1010, the composite beam is then applied to an inside diameter surface of the glass object and to an inner region of the glass object. The inner region is essentially adjacent to and below the inside diameter surface.

At step 1015, the inside diameter surface and the inner region are selectively heated using the composite beam. This causes a first change in the refractive index characteristic of the glass object before the composite beam is moved relative to the glass object at step 1020. Such movement may include rotation, linear translation or a combination of each.

In some embodiments, a reactant gas disposed within the glass object can be heated to cause the reactant gas to selectively react and deposit a coating layer on the inside diameter surface. It is this coating layer that is typically heated at step 1015 to cause the first changed in the refractive index characteristic.

At step 1025, the glass object is again heated. More particularly, a surface adjacent to the starting point on the inside diameter surface and an adjacent region below this adjacent surface are selectively heated with the composite beam. This causes a second changed in the refractive index characteristic of the glass object. Typically, more changes to the object's refractive index characteristic occur as the composite beam and object are moved relative to each other. However, the combination of these refractive index characteristic changes form the desired axially non-uniform refractive gradient within the glass object, such as a planar or helical structure.

Those skilled in the art will appreciate that embodiments consistent with the present invention may be implemented in a variety of technologies and that the foregoing description of an implementation of the invention has been presented for purposes of illustration and description. It is not exhaustive and does not limit the invention to the precise form disclosed. Modifications and variations are possible in light of the above teachings or may be acquired from practicing of the invention.

While the above description encompasses one embodiment of the present invention, the scope of the invention is defined by the claims and their equivalents.

What is claimed is:

1. A method for creating a refractive gradient within a glass tube, comprising the steps of:
applying a beam of laser energy to the glass tube;
penetrating the glass tube with the beam of laser energy to create a channel in the glass tube;
providing the beam of laser energy through the channel to a starting point on a region of the glass tube; and
moving the beam of laser energy relative to the starting point to create the refractive gradient within the region of the glass tube.

2. The method of claim 1, wherein the region comprises an inside diameter surface of the glass tube.

3. The method of claim 2, wherein the providing step further comprises providing the beam of laser energy through the channel to heat a reactant gas disposed within an area defined by the inside diameter surface of the glass tube, thus causing the reactant gas to selectively react and deposit a coating layer on the inside diameter surface.

4. The method of claim 3, wherein the providing step further comprises providing the beam of laser energy to the coating layer causing thermal diffusion of the coating layer into the glass tube.

5. The method of claim 1, wherein the region comprises a coating layer on an inside diameter surface of the glass tube.

6. The method of claim 5, wherein the providing step further comprises providing the beam of laser energy at a first energy level to the coating layer, thus causing migration of the coating layer into the glass tube at a desired depth from the inside diameter surface.

7. The method of claim 5, wherein the providing step further comprises providing the beam of laser energy to the coating layer for a predetermined amount of time, thus causing migration of the coating layer into the glass tube at a desired depth from the inside diameter surface.

8. The method of claim 5, wherein the providing step further comprises selectively focusing the beam of laser energy to a predefined depth within the coating layer to cause migration of the coating layer into the glass tube.

9. The method of claim 5, wherein the providing step further comprises selectively applying the beam of laser energy to the coating layer.

10. The method of claim 1, wherein the moving step further comprises rotating the glass tube while selectively applying the beam of laser energy.

11. The claim of the method of claim 1, wherein the moving step further comprises linearly moving the glass tube along a longitudinal axis of the glass tube while selectively applying the beam of laser energy.

12. The method of claim 1, wherein the moving step further comprises rotating the glass tube around a longitudinal axis of the glass tube and linearly moving the glass tube relative to the longitudinal axis while selectively applying the beam of laser energy.

13. The method of claim 1, further comprising the step of re-fusing the glass tube that is penetrated as the beam of laser is moved relative to the glass tube.

14. A method for creating a refractive gradient within a glass object, comprising the steps of:
focusing a plurality of beams of laser energy as a composite beam at a starting point;
applying the composite beam to an inside diameter surface and an inner region of the glass object below the inside diameter surface;
selectively heating the inside diameter surface and the inner region using the composite beam to cause a first change in the refractive index characteristic of the inside diameter surface and the inner region;
moving the composite beam relative to the glass object; and
selectively heating an adjacent surface and an adjacent region below the adjacent surface with the composite beam to cause a second change in the refractive index characteristic, the first change and the second change forming the refractive gradient within the glass object.

15. The method of claim 14 further comprising the step, prior to selectively heating the inside diameter surface, of heating a reactant gas disposed within the glass object causing the reactant gas to selectively react and deposit a coating layer on the inside diameter surface and the adjacent surface.

16. The method of claim 15, wherein the step of selectively heating the inside diameter surface further comprises selectively heating the coating layer near the inside diameter surface to cause thermal diffusion of the coating layer into the inner region of the glass object; and
wherein the step of selectively heating the adjacent surface further comprises selectively heating the coating layer near the adjacent surface to cause thermal diffusion of the coating layer into the adjacent region of the glass object.

17. The method of claim 16, wherein the step of selectively heating the inside diameter surface step further comprises selectively heating the coating layer near the inside diameter surface for a predetermined amount of time causing migration of the coating layer to a desired depth from the inside diameter surface.

18. The method of claim 17, wherein the step of selectively heating the adjacent surface step further comprises selectively heating the coating layer near the adjacent surface for a predetermined amount of time causing migration of the coating layer to a desired depth from the adjacent surface.

19. The method of claim 14, wherein the moving step further comprises rotating the composite beam relative to the glass object.

20. The method of claim 14, wherein the moving step further comprises linearly moving the composite beam relative to the glass object while selectively applying the composite beam.

21. The method of claim 20, wherein the refractive gradient within the glass object is planar.

22. The method of claim 20, wherein the linearly moving step further comprises rotating the composite beam relative to a longitudinal axis of the glass object and linearly moving the composite beam relative to the glass object.

23. The method of claim 14, wherein the focusing step further comprises adjusting the focal point of each of the beams of laser energy to provide a laser beam focal field.

24. An apparatus for creating a refractive gradient within a glass tube, comprising:
a controller;
a laser energy source in communication with the controller, the laser energy source being capable of selectively providing a beam of laser energy at a selectable energy level; and
a reflective conduit configured to receive the beam of laser energy from the laser energy source and in communication with the controller, the reflective conduit being operative to selectively direct the beam of laser energy to dopant material on an inside diameter (ID) surface of the glass tube causing thermal diffusion of the dopant material into the glass tube in response to signals from the controller, the reflective conduit being further operative to move the beam of laser energy relative to the ID surface in response to the signals causing further thermal diffusion of the dopant material and creating the refractive gradient within the glass tube.

25. The apparatus of claim 24, wherein the reflective conduit is further operative to provide the beam of laser energy to a reactant gas disposed within an area defined by the ID surface of the glass tube, thus causing the reactant gas to heat and deposit the dopant material on the ID surface within the glass tube.

26. The apparatus of claim 24, wherein the laser energy source is further operative to provide the beam of laser energy to the dopant material via the reflective conduit for a predetermined amount of time, thus causing migration of the dopant material into the glass tube at a desired depth from the ID surface.

27. The apparatus of claim 24, wherein the reflective conduit is further operative to rotate the orientation of the beam of laser energy relative to the glass tube while the laser energy source selectively provides the beam of laser energy at the selectable energy level.

28. The apparatus of claim 24, wherein the reflective conduit is further operative to linearly move the beam of laser energy relative to a longitudinal axis of the glass tube while the laser energy source selectively provides the beam of laser energy at the selectable energy level.

29. The apparatus of claim 24, wherein the reflective conduit is further operative to rotate the orientation of the beam of laser energy relative to the glass tube and to linearly move the beam of laser energy relative to a longitudinal axis of the glass tube while the laser energy source selectively provides the beam of laser energy at the selectable energy level.

30. The apparatus of claim 24 further comprising a movable working surface configured to support the glass tube as the beam of laser energy is applied to the glass tube by the reflective conduit, the movable working surface being operative to move the glass tube as the beam of laser energy is selectively applied by the laser energy source and the reflective conduit.

31. An apparatus for creating a refractive gradient within a glass tube, comprising:
a programmable controller capable of executing instructions and producing laser control signals and working surface control signals;
a laser energy source in communication with the programmable controller, the laser energy source being capable of selectively providing a beam of laser energy to dopant material on an inside diameter (ID) surface of the glass tube in response to the laser control signals; and
a movable working surface in communication with the controller, the movable working surface being positioned relative to the laser energy source and configured to support the glass tube as the beam of laser energy is applied to the dopant material on the ID surface of the glass tube causing thermal diffusion of the dopant material into the glass tube, the movable working surface being further operative to selectively move the glass tube relative to the ID surface in response to the working surface control signals as the beam of laser energy is selectively applied from the laser energy source causing further thermal diffusion of the dopant material and creating the refractive gradient within the glass tube.

32. The apparatus of claim 31, wherein the laser energy source is further operative to provide the beam of laser energy through a channel to a reactant gas disposed within an area defined by the ID surface of the glass tube, thus causing the reactant gas to heat and deposit the dopant material on the ID surface within the glass tube.

33. The apparatus of claim 31, wherein the laser energy source is further operative to provide the beam of laser energy to the dopant material for a predetermined amount of time, thus causing migration of the dopant material into the glass tube at a desired depth from the ID surface.

34. The apparatus of claim 31, wherein the movable working surface is further operative to rotate the glass tube relative to the orientation of the beam of laser energy while the laser energy source selectively provides the beam of laser energy at the selectable energy level.

35. The apparatus of claim 34, wherein the movable working surface is a rotating lathe and adjustable chuck for supporting the glass tube.

36. The apparatus of claim 31, wherein the movable working surface is further operative to linearly move the glass tube along a longitudinal axis of the glass tube while the laser energy source selectively provides the beam of laser energy at the selectable energy level.

37. The apparatus of claim 31, wherein the movable working surface is further operative to rotate the orientation of the glass tube relative to the beam of laser energy and to linearly move the glass tube along a longitudinal axis of the glass tube while the laser energy source selectively provides the beam of laser energy at the selectable energy level.
